(19) United States
(12) Patent Application Publication
(10) Pub. No.: US 2023/0071594 A1
(43) Pub. Date: Mar. 9, 2023

(54) Flexible LED Light Tube

(71) Applicant: Sikai Chen, Delran, NJ (US)

(72) Inventor: Sikai Chen, Delran, NJ (US)

(21) Appl. No.: 17/820,278

(22) Filed: Aug. 17, 2022

Related U.S. Application Data
(60) Provisional application No. 63/242,116, filed on Sep. 9, 2021.

(51) Int. Cl. F21S 4/24

(52) U.S. Cl. CPC F21S 4/24; F21Y 2115/10

(57) ABSTRACT

A flexible LED light tube has an elongated light tube body having a channel which extends the length of the body and LED light tape having LED lights mounted thereon, also extending completely through the channel and the length of the channel. An LED light tape supporting member which extends through the channel is fabricated of a flexible, bendable material, such that the light tube body can easily be formed into a curvilinear, rounded shape and then independently and contemporaneously be maintained in that shape without the need for attachment devices or other form fitting means.

### RELATED APPLICATION

This application claims the benefit of provisional application No. 63/242,116, filed on Sep. 9, 2021.

### FIELD OF THE INVENTION

The present invention relates to LED lighting systems and specifically to elongated, flexible LED light tubes.

### BACKGROUND OF THE INVENTION

Flexible, elongated light strips or tubes, including those which utilize LED lamps, have commonly been used for a variety of purposes; for example, in decorative lighting in residential and commercial settings, kitchen cabinet lighting, staircase lighting, ceiling lighting, vehicle lighting, safety lighting.

Regardless of the uses to which flexible light tubes have been put, all such current lighting tubes, once they are bent and configured to meet their particular needs, will not maintain that configuration, in most cases a curvilinear shape. They must be held in position by attachment devices like clamps, brackets, screws, etc. in order to assure that they retain their shape. There are presently no light tubes which effectively maintain a user's desired curved or rounded configuration and shape without the use of outside attachment means.

### SUMMARY OF THE INVENTION

It is thus the object of the present invention to overcome the limitations and disadvantages of existing light tubes, particularly with regard to retaining the desired shapes and configurations of the light tubes.

This and other objects are accomplished by the present invention, a flexible LED light tube which comprises an elongated light tube body having a channel which extends the length of the body and LED light tape having LED lights mounted thereon, also extending completely through the channel and the length of the channel. An LED light tape supporting member which extends through the channel is fabricated of a flexible, bendable material, such that the light tube body can easily be formed into a curvilinear, rounded shape and then contemporaneously be maintained in that shape without the need for attachment devices or other form fitting means.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is a partial sectional end view of the light tube of the present invention.

FIG. 2 is a partial sectional end view of the opposite side of the light tube shown in FIG. 1.

FIG. 3 is a partial sectional end view of another embodiment of the present invention.

FIG. 4 is a partial sectional end view of a third embodiment of the present invention.

FIG. 5 is a partial sectional end view of a fourth embodiment of the present invention.

### DETAILED DESCRIPTION OF THE INVENTION

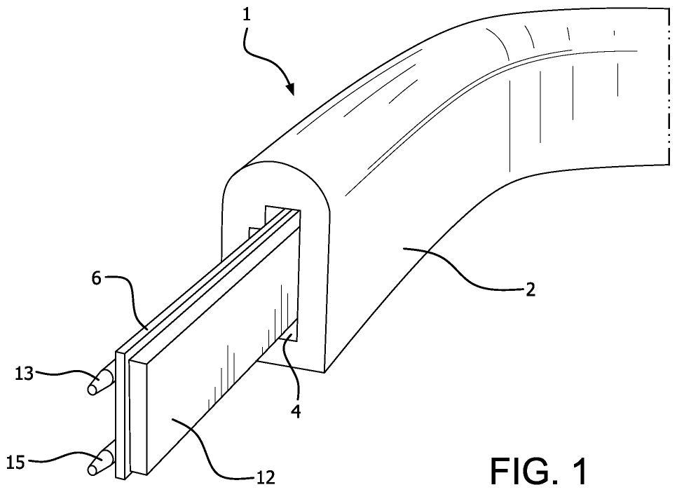

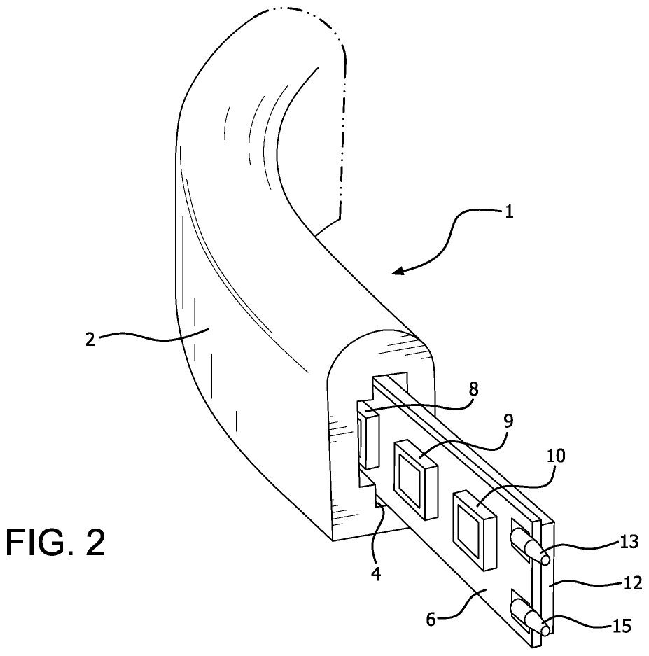

Flexible light tube 1 of the present invention, as illustrated in FIGS. 1 and 2, comprises light tube body 2 having through channel 4 which extends the length of the light tube. Light tube 1 is commonly fabricated out of flexible, formed plastic or like flexible material. LED light tape 6, on which LED lights 8, 9, and 10 are mounted, extends completely through channel 4 and through the length of the channel. Electrical contacts 13 and 15 extend from LED light tape 6. LED light tape supporting member 12 also extends completely through channel 4 and through the length of the channel and is attached to and supports LED light tape 6. Supporting member 12 is a support strip fabricated out of flexible, bendable aluminum or like flexible, bendable material. Therefore, it is evident that, in accordance with this unique design, the present invention provides a flexible LED light tube which can be formed into a curvilinear configuration, which configuration is independently maintained without the need for attachment devices or other form fitting means.

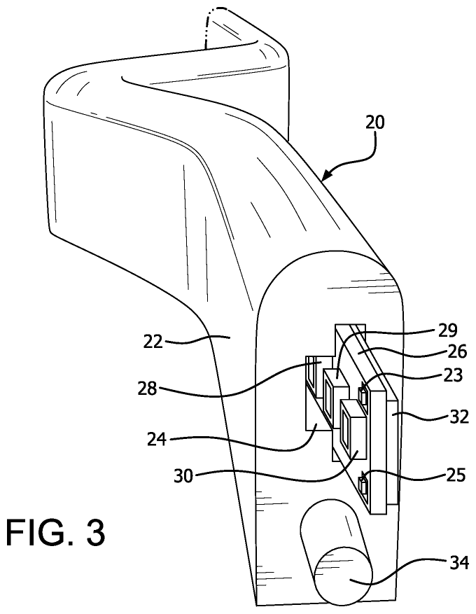

FIG. 3 illustrates a second embodiment of the invention showing a similar light tube 20, light tube body 22, through channel 24, LED light tape 26, on which LED lights 28, 30, and 32 and contacts 23 and 25 are mounted, and LED light tape supporting member 32. As with the embodiment shown in FIGS. 1 and 2, light tube body 22, channel 24, LED light tape 26 and supporting member 32 all extend the length of light tube 20. However, in this embodiment, thin, flexible, bendable steel wire 34 extends through light tube body 22, below channel 24, and through the length of the light tube body. The addition of steel wire 34 provides some rigidity to light tube 20, while still ensuring for the bendability, flexibility, and ability to independently and contemporaneously maintain a desired shape.

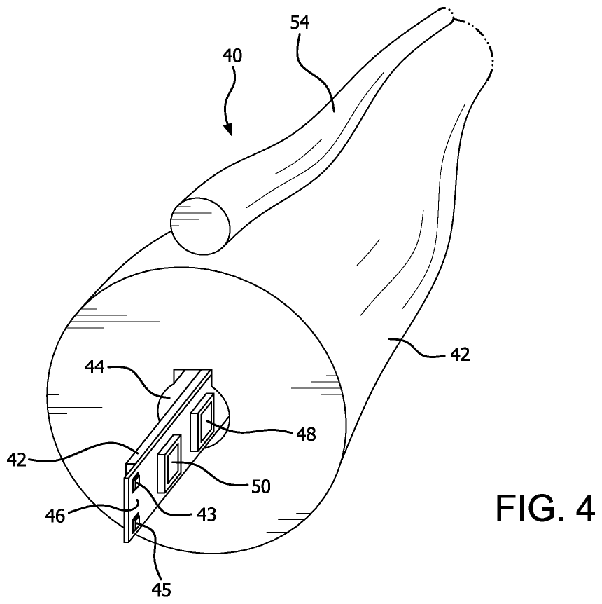

FIG. 4 is a third embodiment of the invention showing a similar light tube 40, light tube body 42, through channel 44, LED light tape 46, on which LED lights 48 and 50 and contacts 43 and 45 are mounted, and LED light tape supporting member 52. As with the embodiment shown in FIGS. 1 and 2, light tube body 42, channel 44, LED light tape 46, and supporting member 42 all extend the length of light tube 40. In this embodiment, thin, flexible, bendable steel wire 54 is located on top of light tube body 42, and the length of the light tube body. Again, the addition of steel wire 54 provides some rigidity to light tube 40, while still ensuring for the bendability, flexibility, and ability to independently and contemporaneously maintain a desired shape.

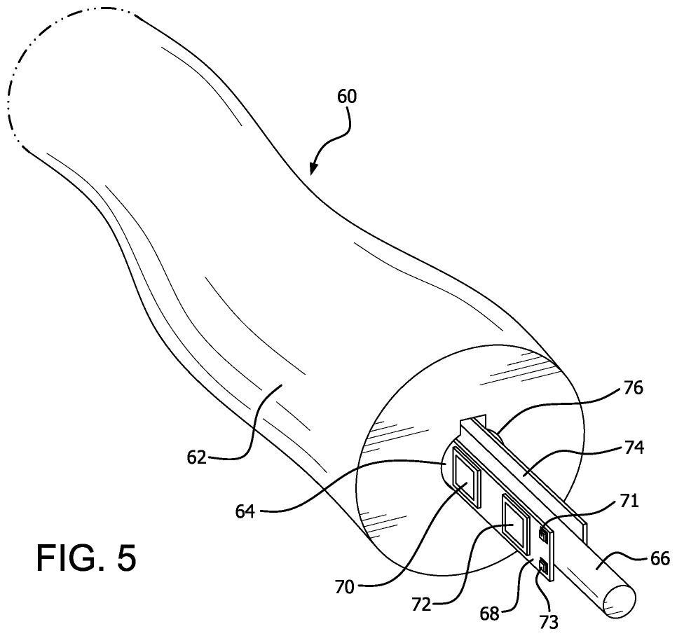

FIG. 5 is a fourth embodiment of the invention showing a similar light tube 60, light tube body 62 and through channel 64. As with the embodiment shown in FIGS. 1 and 2, light tube body 62 and channel 64 extend the length of light tube 60. In this embodiment, thin, flexible, bendable steel wire 66 extends through light tube body 62, and through the length of the light tube body. In this embodiment as well, the addition of steel wire 66 provides some rigidity to light tube 60, while still ensuring for the bendability, flexibility, and ability to independently maintain a desired shape remains. LED light tape 68, with LED lights 70 and 72 and contacts 71 and 73 mounted thereon, is adhered by adhesive or like means to one side of steel wire 66 and LED light tape 74 with mounted LED lights (only one 76 being shown and contacts identical to 71 and 73) is adhered to the opposite side of the steel wire. Steel wire 66 functions as the light tape supporting member in this regard. The unique design of this embodiment not only allows light tube 60 to have the flexibility and the ability of the light tube to independently and contemporaneously maintain its shape, but also increases the illumination of the light tube, since LED lights shine from opposite sides of light tube body 62.

The flexible, malleable light tube of the present invention, in any of its embodiments, can easily be formed into any desired shape and, most significantly, be contemporaneously and independently formed to retain that shape, without the assistance of any form fitting device or attachment means.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A flexible light tube comprising:
an elongated light tube body having a channel which extends the length of the body;
LED light tape having LED lights mounted thereon, the light tape extending completely through the channel and the length of the channel;
an LED light tape supporting member extending through the channel and the length of the channel, supporting the LED light tape within the channel, the supporting member being fabricated of a flexible, bendable material, such that the light tube body can be bent and formed into a variety of curvilinear configurations and contemporaneously and independently maintained in said configurations without the need for attachment devices or other form fitting means.

2. The flexible light tube as in claim 1 wherein the LED light tape supporting member is a support strip fabricated out of flexible, bendable material.

3. The flexible light tube as in claim 1 wherein the LED light tape supporting member is a flexible, bendable steel wire.

4. The flexible light tube as in claim 1 wherein a flexible, bendable steel wire extends through the light tube body and the length of the body.

5. The flexible light tube as in claim 1 wherein a flexible, bendable steel wire is located on top of the light tube body and extends the length of the body.

6. The flexible light tube as in claim 2 wherein a flexible, bendable steel wire extends through the light tube body and the length of the body.

7. The flexible light tube as in claim 3 wherein LED light tape is located and attached to opposite sides of the steel wire.
